(19) United States
(12) Patent Application Publication
(10) Pub. No.: US 2024/0289735 A1
(43) Pub. Date: Aug. 29, 2024

(54) EXTERNAL INFORMATION ACQUIRING DEVICE, METHOD FOR ACQUIRING EXTERNAL INFORMATION, AND NON-TRANSITORY COMPUTER-READABLE STORAGE MEDIUM STORING A COMPUTER PROGRAM

(71) Applicant: SUMITOMO ELECTRIC INDUSTRIES, LTD., Osaka-shi, Osaka (JP)

(72) Inventors: Yu URATA, Osaka-shi (JP); Takeshi HACHIKAWA, Osaka-shi (JP)

(73) Assignee: SUMITOMO ELECTRIC INDUSTRIES, LTD., Osaka-shi, Osaka (JP)

(21) Appl. No.: 18/292,526

(22) PCT Filed: Apr. 28, 2022
(86) PCT No.: PCT/JP2022/019234

§ 371 Date: Jan. 26, 2024

(30) Foreign Application Priority Data
Aug. 18, 2021 (JP) 2021-133123

(51) Int. Cl. G06Q 10/0835

(52) U.S. Cl. CPC G06Q 10/08355

(57) ABSTRACT

An external information acquiring device includes a record information acquiring circuit configured to acquire record information indicating a delivery record of a parcel by a vehicle, an external information acquiring circuit configured to acquire, based on the acquired record information, external information on an event based on which there is a possibility of occurrence of a temporal difference between the delivery record and a delivery plan of the parcel by the vehicle, and a storage control circuit configured to write the acquired external information in a storage device.

### TECHNICAL FIELD

The present disclosure relates to an external information acquiring device, a method for acquiring external information, and a computer program. This application claims priority based on Japanese Patent Application No. 2021-133123 filed on Aug. 18, 2021, the entire contents of which are incorporated herein by reference.

### BACKGROUND ART

Conventionally, delivery plan systems are known which plan a delivery route to a destination of a parcel, a scheduled arrival time, a scheduled stay time at the destination, and the like.

In a case where a delivery plan is unreasonable, it is necessary to analyze a factor that causes a difference between the plan and the record, and to make a structure to improve the plan to a new delivery plan. For factor analysis, it is necessary to acquire external information on an event based on which there is a possibility of affecting a delivery record, such as traffic information and weather information, in addition to a delivery record of a parcel by a worker. The acquired external information is stored in a storage device such as a hard disk drive (HDD) for the factor analysis.

PTL 1 discloses a method for storing measurement data of a sensor in a storage device in advance for factor analysis of an abnormality of a machine system. In PTL 1, in order to reduce the stored data, the measurement period of measurement data to be stored is controlled by using the abnormality frequency and the remaining life of the machine system.

### CITATION LIST

### Patent Literature

PTL 1: WO 2016/199210

### SUMMARY OF INVENTION

An external information acquiring device according to one aspect of the present disclosure includes a record information acquiring unit configured to acquire record information indicating a delivery record of a parcel by a vehicle; an external information acquiring unit configured to acquire, based on the acquired record information, external information on an event based on which there is a possibility of occurrence of a temporal difference between the delivery record and a delivery plan of the parcel by the vehicle; and a storage control unit configured to write the acquired external information in a storage device.

A method for acquiring external information according to another aspect of the present disclosure includes acquiring, by an external information acquiring device, record information indicating a delivery record of a parcel by a vehicle; acquiring, by the external information acquiring device, based on the acquired record information, external information on an event based on which there is a possibility of occurrence of a temporal difference between the delivery record and a delivery plan of the parcel by the vehicle; and writing, by the external information acquiring device, the acquired external information in a storage device.

A computer program according to another aspect of the present disclosure causes a computer to function as a record information acquiring unit configured to acquire record information indicating a delivery record of a parcel by a vehicle; an external information acquiring unit configured to acquire, based on the acquired record information, external information on an event based on which there is a possibility of occurrence of a temporal difference between the delivery record and a delivery plan of the parcel by the vehicle; and a storage control unit configured to write the acquired external information in a storage device.

The present disclosure can also be implemented as a computer program for causing a computer to execute the characteristic steps included in the method for acquiring external information. It is needless to say that such a computer program can be distributed via a computer-readable non-transitory recording medium such as a compact disc-read only memory (CD-ROM) or a communication network such as the Internet. The present disclosure can also be implemented as a semiconductor integrated circuit that constitutes a part or all of the external information acquiring device, or as a system including the external information acquiring device.

### BRIEF DESCRIPTION OF THE DRAWINGS

FIG. 1 is a diagram showing an overall configuration of a schedule/record management system according to Embodiment 1 of the present disclosure. FIG. 2 is a block diagram showing a structure of a schedule/record analyzing device.

FIG. 3 is a diagram showing an example of a result of a factor analysis displayed on a display device by a display control unit.

FIG. 4 is a diagram for illustrating a method for identifying an arrival record time at a destination and a departure record time from the destination by a record information acquiring unit.

FIG. 5 is a flowchart showing an example of processing steps of the schedule/record analyzing device.

FIG. 6 is a diagram showing an example of a result of a factor analysis displayed on the display device by a factor analyzing unit.

### DETAILED DESCRIPTION

### Problems to be Solved by Present Disclosure

External information is generally available for a charge. However, conventionally, since there is no structure for efficiently acquiring the external information, a delivery plan system, for example, acquires external information at all times throughout the country and stores the external information in a storage device. Therefore, the cost for acquiring the external information and the cost for maintaining the external information stored in the storage device are enormous. It is difficult to apply the method described in PTL 1 to external information in a delivery record.

The present disclosure has been made in view of such circumstances, and an object of the present disclosure is to provide an external information acquiring device, a method for acquiring external information, and a computer program that can acquire external information on an event based on which there is a possibility of affecting a delivery record for a delivery plan at low cost.

### Advantageous Effects of Present Disclosure

According to the present disclosure, external information on an event based on which there is a possibility of affecting a delivery record can be acquired for a delivery plan at low cost.

### Description of Embodiments of Present Disclosure

### Overview of Embodiments of Present Disclosure

First, an overview of embodiments of the present disclosure will be listed and described.

(1) An external information acquiring device according to an embodiment of the present disclosure includes a record information acquiring unit configured to acquire record information indicating a delivery record of a parcel by a vehicle; an external information acquiring unit configured to acquire, based on the acquired record information, external information on an event based on which there is a possibility of occurrence of a temporal difference between the delivery record and a delivery plan of the parcel by the vehicle; and a storage control unit configured to write the acquired external information in a storage device.

According to this configuration, the external information can be acquired and stored in the storage device after narrowing down the area and the time of the external information on an event based on the record information. This makes it possible to acquire the external information at low cost.

(2) The record information may include travel position information of the vehicle. The external information acquiring unit may be configured to acquire the external information, based on the travel position information.

According to this configuration, for example, external information around the travel position of the vehicle is acquired, while external information in other positional range is not acquired, so that the area for acquiring external information can be narrowed down.

(3) The external information may include at least one of weather information, traffic information, state information of an inside of a trunk of the vehicle, state information of the vehicle, state information of a worker who performs delivery work of the parcel by the vehicle, traffic signal information, or fee information of a toll road.

According to this configuration, various kinds of external information on an event based on which there is a possibility of affecting the delivery record can be acquired for the delivery plan at low cost.

(4) The external information acquiring device may further include a plan information acquiring unit configured to acquire plan information indicating the delivery plan. The external information acquiring unit may be configured to identify, based on the plan information and the record information, a travel period of the vehicle and a stay period during which the vehicle stays at a destination for the parcel, and to change a combination of pieces of the external information to be acquired during the travel period and the stay period.

According to this configuration, appropriate external information can be acquired in accordance with the state of the vehicle, based on the plan information and the record information.

(5) In addition, the external information acquiring unit may be is configured to acquire the weather information and the traffic information during the travel period and to acquire the weather information during the stay period.

In a period during which the vehicle travels, it is highly necessary to acquire the traffic information. On the other hand, the necessity of acquiring the traffic information is low in a period during which the vehicle stays at the destination. Therefore, this configuration allows the acquisition of external information necessary for factor analysis of the difference between the plan and the record, and avoids the acquisition of external information unnecessary for factor analysis.

(6) The external information acquiring unit may be configured to determine, based on the acquired external information, a frequency for acquiring the external information.

According to this configuration, in a case where it can be determined that an unusual event has occurred based on the external information, it is possible to take measures such as acquiring the external information at a higher frequency than usual.

(7) In addition, the external information acquiring unit may be configured to increase a frequency for acquiring the weather information in a case where the weather information acquired as the external information indicates an abnormal weather, compared with a case where the weather information indicates a normal weather.

According to this configuration, the weather information indicating abnormal weather can be acquired at a higher frequency than usual, and thus the weather information based on which there is a possibility of affecting the delivery record can be acquired at a high frequency, thereby contributing to accurate factor analysis.

(8) Furthermore, the external information acquiring unit may be configured to further acquire weather forecast information and to determine, based on the weather forecast information, a frequency for acquiring weather information as the external information.

According to this configuration, for example, in a case where a possibility that a rainfall will increase is detected based on the weather forecast information, it is possible to take measures such as acquiring the weather information at a higher frequency than usual. This can contribute to accurate factor analysis.

(9) The storage control unit may be configured to write changed external information in the storage device, among pieces of the acquired external information.

According to this configuration, in a case where there is a change in the external information, the external information can be stored in the storage device, and in a case where there is no change in the external information, the external information is not stored in the storage device. This can reduce the capacity of the external information stored in the storage device, thereby reducing the maintenance cost of the external information.

(10) A method for acquiring external information according to another embodiment of the present disclosure includes acquiring, by an external information acquiring device, record information indicating a delivery record of a parcel by a vehicle; acquiring, by the external information acquiring device, based on the acquired record information, external information on an event based on which there is a possibility of occurrence of a temporal difference between the delivery record and a delivery plan of the parcel by the vehicle; and writing, by the external information acquiring device, the acquired external information in a storage device.

This configuration includes characteristic processing in the above-described external information acquiring device as steps. Therefore, according to this configuration, the same function and effect as those of the above-described external information acquiring device can be achieved.

(11) A computer program according to another embodiment of the present disclosure causes a computer to function as a record information acquiring unit configured to acquire record information indicating a delivery record of a parcel by a vehicle; an external information acquiring unit configured to acquire, based on the acquired record information, external information on an event based on which there is a possibility of occurrence of a temporal difference between the delivery record and a delivery plan of the parcel by the vehicle; and a storage control unit configured to write the acquired external information in a storage device.

This configuration can cause the computer to function as the above-described external information acquiring device. Therefore, the same function and effect as those of the above-described external information acquiring device can be achieved.

### Details of Embodiments of Present Disclosure

Hereinafter, embodiments of the present disclosure will be described with reference to the drawings. Each of the embodiments described below is a specific example of the present disclosure. Numerical values, shapes, materials, components, arrangements and connection configurations of the components, steps, order of the steps, and the like shown in the following embodiments are mere examples, and do not limit the present disclosure. Furthermore, among the components in the following embodiments, components not recited in the independent claims are components that can be added as desired. Each of figures is a schematic view and is not necessarily illustrated strictly.

The same components are denoted by the same reference numerals. The functions and names of these components are the same, and thus the description thereof will be omitted as appropriate.

### EMBODIMENT 1

### Overall Configuration of Schedule/Record Management System

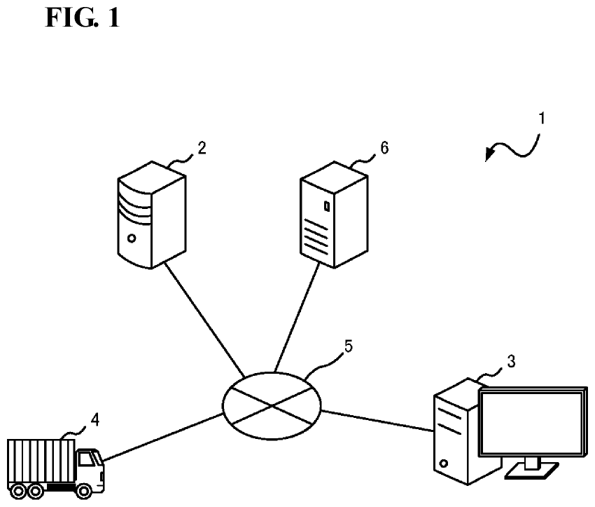

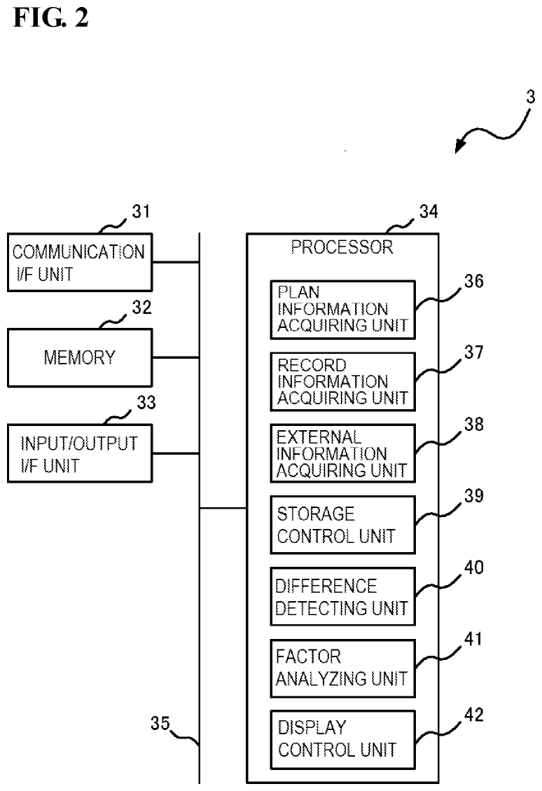

FIG. 1 is a diagram showing an overall configuration of a schedule/record management system according to Embodiment 1 of the present disclosure. Referring to FIG. 1, a schedule/record management system 1 is a system for managing plan information indicating a delivery plan of a parcel by a vehicle 4 and record information indicating a delivery record of the parcel by vehicle 4, and includes a delivery plan creating device 2, a schedule/record analyzing device 3, vehicle 4, and an external information providing device 6. Delivery plan creating device 2 is a device configured to create plan information indicating the delivery plan of the parcel by vehicle 4 on which a worker rides. The worker performs delivery work of the parcel by vehicle 4.

Schedule/record analyzing device 3 acquires the plan information and the record information from delivery plan creating device 2 and vehicle 4, respectively, and acquires external information on an event based on which there is a possibility of affecting the delivery record from external information providing device 6, based on the acquired plan information and the acquired record information.

The plan information includes information on a destination of the parcel, a delivery date, an address of the destination, coordinates of the destination, a state of a worker who performs work for the parcel at the destination, and a duration of the state. For example, the plan information indicates that the parcel is delivered to the destination on “Jan. 5, 2021”. The plan information also indicates that the address of the destination is “XXX, B city, A prefecture” and the coordinates of the destination (latitude, longitude) are “YY. 3715, ZZZ. 5250”. Furthermore, the plan information indicates that, as the work of the worker for the parcel at the destination, incidental work is performed for 10 minutes, loading or unloading for the parcel is performed for 5 minutes, waiting for the parcel is performed for 5 minutes, and rest is taken for 10 minutes.

The record information includes information on the travel position and the travel time of vehicle 4 and information on the work content performed by the worker as a delivery record of the parcel. The worker inputs the work content to a terminal installed in vehicle 4 or a terminal carried by the worker. The input work content is provided from vehicle 4 to schedule/record analyzing device 3. However, the terminal carried by the worker may provide the work content to schedule/record analyzing device 3.

Schedule/record analyzing device 3 detects a temporal difference between the delivery plan and the delivery record based on the plan information and the record information, and analyzes a factor causing the temporal difference based on the detection result and the external information. Schedule/record analyzing device 3 transmits the analysis result to delivery plan creating device 2. Upon receiving the analysis result, delivery plan creating device 2 modifies the next and subsequent plan information based on the analysis result. Schedule/record analyzing device 3 displays the analysis result on a display device such as a liquid crystal display.

Vehicle 4 is a vehicle used by the worker to deliver the parcel, and is, for example, a freight car such as a truck or a van. Vehicle 4 includes a position identification unit configured to identify the position of vehicle 4. The position identification unit identifies the position of vehicle 4 by using satellite navigation. For example, the position identification unit identifies the position of vehicle 4 based on the radio waves received from a plurality of GPS satellites. The position of vehicle 4 can be identified by, for example, latitude and longitude. The satellite navigation uses a global navigation satellite system (GNSS) such as GPS, but is not limited to GPS. It is desirable that vehicle 4 includes a speedometer for measuring the travel speed of vehicle 4.

External information providing device 6 provides schedule/record analyzing device 3 with the external information on an event based on which there is a possibility of affecting the delivery record, that is, the external information on an event based on which there is a possibility of causing a difference between the delivery plan and the delivery record.

The external information provided by external information providing device 6 to schedule/record analyzing device 3 includes at least one of weather information, traffic information, traffic signal information, or fee information of toll road.

External information providing device 6 may provide the external information to schedule/record analyzing device 3 based on a request from schedule/record analyzing device 3. For example, external information providing device 6 may provide the external information to schedule/record analyzing device 3 based on at least one of a position, an area, a time, and a time period designated by schedule/record analyzing device 3. As an example, schedule/record analyzing device 3 transmits the travel position and the travel time of vehicle 4 to external information providing device 6. External information providing device 6 provides weather information at the travel time in an area including the travel position of vehicle 4 to schedule/record analyzing device 3. External information providing device 6 provides schedule/record analyzing device 3 with traffic information including traffic congestion information at the travel time in an area including the travel position of vehicle 4. External information providing device 6 may provide at least one of traffic signal information or fee information of a toll road in an area including the travel position of vehicle 4 to schedule/record analyzing device 3.

Vehicle 4 may provide schedule/record analyzing device 3 with the external information. For example, in a case where a camera is installed in a trunk or the interior of vehicle 4, schedule/record analyzing device 3 may provide a camera image as external information. As an example, schedule/record analyzing device 3 determines, based on the plan information and the record information, whether vehicle 4 is during travel or stay at the destination in accordance with the delivery plan. At the time when vehicle 4 is determined to be during travel or stay at the destination, schedule/record analyzing device 3 requests vehicle 4 to transmit the camera image and acquires the camera image from vehicle 4 as the external information.

Vehicle 4 may provide state information (for example, data flowing through an in-vehicle network such as a controller area network (CAN)) of vehicle 4 to schedule/record analyzing device 3 as external information.

Furthermore, the terminal carried by the worker may provide state information of the worker (for example, biometric information such as a heart rate of the worker) to schedule/record analyzing device 3 as the external information.

Delivery plan creating device 2, schedule/record analyzing device 3, vehicle 4, and external information providing device 6 are connected to a network 5 such as the Internet by wire or wirelessly, and can transmit and receive data to and from each other.

### Configuration of Schedule/Record Analyzing Device 3

FIG. 2 is a block diagram showing a structure of schedule/record analyzing device 3. Referring to FIG. 2, schedule/record analyzing device 3 includes a communication interface (I/F) unit 31, a memory 32, an input/output I/F unit 33, and a processor 34 which are interconnected via a bus 35.

Communication I/F unit 31 includes a communication module for schedule/record analyzing device 3 to communicate with an external device by wire or wireless.

Memory 32 is a storage device, and includes a volatile memory element such as a static RAM (SRAM) or a dynamic RAM (DRAM), a nonvolatile memory element such as a flash memory or an electrically erasable programmable read only memory (EEPROM), a magnetic storage device such as a hard disk, or the like. Memory 32 stores a computer program executed by processor 34. Memory 32 stores data used during execution of the computer program and data generated during the execution of the computer program.

Input/output I/F unit 33 includes an interface for connecting an input device such as a keyboard or a mouse and an output device (display device) such as a liquid crystal display to schedule/record analyzing device 3.

Processor 34 is configured by a central processing unit (CPU) or the like, and includes a plan information acquiring unit 36, a record information acquiring unit 37, an external information acquiring unit 38, a storage control unit 39, a difference detecting unit 40, a factor analyzing unit 41, and a display control unit 42 as functional processing units implemented by executing the computer program stored in memory 32.

### Plan Information Acquiring Unit 36

Plan information acquiring unit 36 acquires the plan information from delivery plan creating device 2 via communication I/F unit 31. Plan information acquiring unit 36 stores the acquired plan information in memory 32.

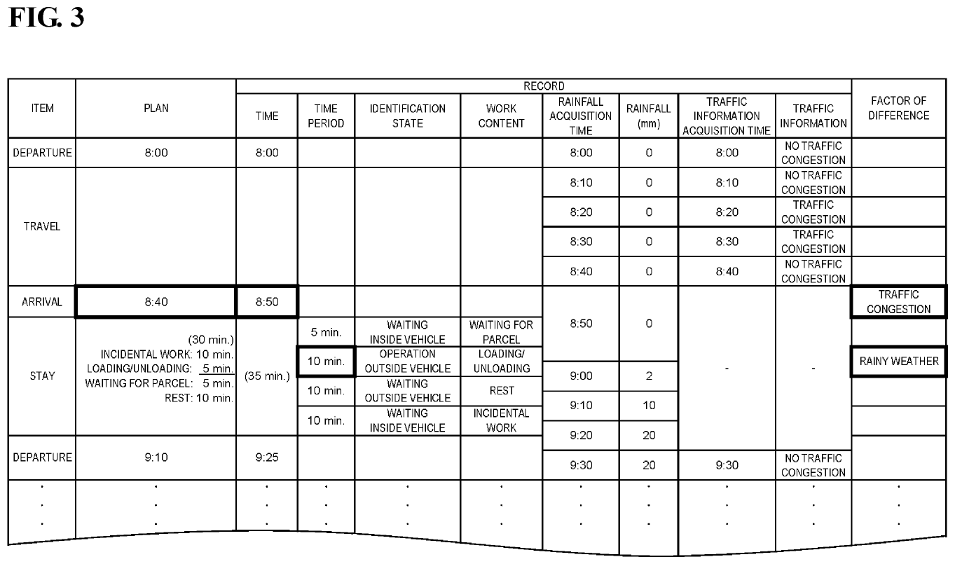

FIG. 3 is a diagram showing an example of a result of a factor analysis displayed on a display device by display control unit 42 described later. FIG. 3 shows part of the plan information. For example, the plan information indicates that the scheduled departure time of vehicle 4 from the base is “8:00”, and the scheduled arrival time at the destination is “8:40”. In addition, the plan information assigns “30 minutes” as the scheduled work time at the destination. The plan information indicates that the breakdown of the work is “10 minutes” for incidental work, “5 minutes” for loading/unloading, “5 minutes” for waiting for a parcel, and “10 minutes” for rest. The plan information also indicates that the scheduled departure time of the destination is “9:10”. The plan information includes position information of the base and the destination, delivery route information from the base to the destination, and the like.

### Record Information Acquiring Unit 37

Referring again to FIG. 2, record information acquiring unit 37 acquires the record information from vehicle 4 via communication I/F unit 31. Record information acquiring unit 37 stores the acquired record information in memory 32.

As described above, the record information includes information on the travel position, the travel speed, and the travel time of vehicle 4, and information on the work content performed by the worker. Record information acquiring unit 37 collates the information of the travel position and the travel time of vehicle 4 with the position information of the base and the destination indicated in the plan information to identify departure record time from the base, arrival record time at the destination, departure record time from the destination, and the like of vehicle 4.

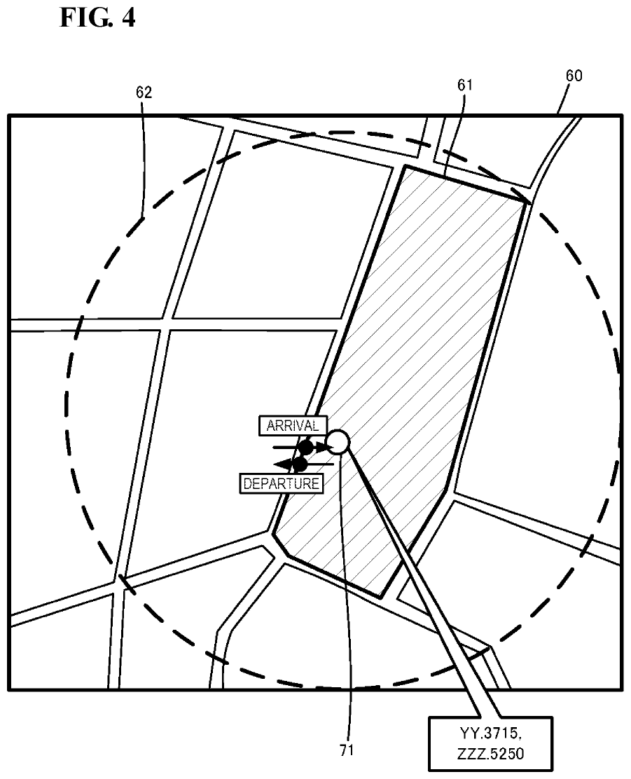

FIG. 4 is a diagram for illustrating a method for identifying the arrival record time at the destination and the departure record time from the destination by record information acquiring unit 37. The departure record time from the base and the arrival record time at the base can be identified in the same manner.

FIG. 4 shows a map 60 indicating a geofence 61 which is an area including the destination. Geofence 61 is identified from map information and the address of the destination indicated in the plan information. Record information acquiring unit 37 calculates the minimum time and the maximum time of the travel time based on the record information including the travel position within geofence 61 among the record information stored in memory 32. Record information acquiring unit 37 identifies the minimum time of the travel time as the arrival record time to the destination, and identifies the maximum time of the travel time as the departure record time from the destination.

In a case where the area of the destination cannot be identified accurately as in geofence 61, record information acquiring unit 37 may set, as a geofence 62, an area based on a first point 71 indicated by the coordinates of the destination (here, the coordinates (YY. 3715, ZZZ. 5250) consisting of movement and longitude) indicated in the plan information. For example, record information acquiring unit 37 sets an area within X meters from first point 71 as geofence 62. Record information acquiring unit 37 identifies a first travel time at which the travel speed becomes zero as the arrival record time at the destination and a last travel time at which the travel speed becomes zero as the departure record time from the destination based on record information including the travel position within geofence 62. The shape of geofence 62 is not limited to a circle, and may be another shape such as an ellipse or a polygon including a quadrangle.

The record information may not include the travel speed. In this case, record information acquiring unit 37 calculates the travel speed from a plurality of travel times and travel positions at the respective travel times.

FIG. 3 shows part of the record information. For example, the record information indicates that the departure record time from the base is “8:00” and the arrival record time at the destination is “8:50”. The record information indicates that work record time at the destination is “35 minutes”. The record information indicates that the breakdown of the work is “5 minutes” for waiting for a parcel, after that, “10 minutes” for loading/unloading, then “10 minutes” for rest, and finally “10 minutes” for incidental work. The record information indicates an identification state (the state of the worker) corresponding to each work content. For example, the identification state corresponding to the “waiting for a parcel” and the “incidental work” is “waiting inside vehicle”, the identification state corresponding to the “loading/unloading” is “operation outside vehicle”, and the identification state corresponding to the “rest” is “waiting outside vehicle”. The record information indicates that the departure record time from the destination is “9:25”.

### External Information Acquiring Unit 38

Referring again to FIG. 2, external information acquiring unit 38 receives external information on an event based on which there is a possibility of causing a temporal difference between the delivery plan and the delivery record from external information providing device 6 via communication I/F unit 31, based on the record information acquired by record information acquiring unit 37. Here, an example of acquiring weather information and traffic information will be described. However, other external information can be acquired in the same manner.

External information acquiring unit 38 includes the travel position information and the travel time information of vehicle 4 indicated by the record information in request information for the weather information, and transmits the request information to external information providing device 6 via input/output I/F unit 33. The request information for the weather information is transmitted, for example, every time the travel time elapses 10 minutes. However, the transmission interval of the request information is not limited to 10 minutes.

External information providing device 6 receives the request information for the weather information from schedule/record analyzing device 3, and transmits the weather information of the area including the travel position at the travel time (for example, the area within a predetermined distance from the travel position) to schedule/record analyzing device 3. External information acquiring unit 38 acquires the weather information corresponding to the travel time and the travel position from external information providing device 6 via communication I/F unit 31.

External information acquiring unit 38 includes the travel position information and the travel time information of vehicle 4 indicated by the record information in the request information of the traffic information, and transmits the request information to external information providing device 6 via input/output I/F unit 33. The request information for the traffic information is transmitted, for example, every time the travel time elapses 10 minutes. However, the transmission interval of the request information is not limited to 10 minutes.

External information providing device 6 receives the request information for the traffic information from schedule/record analyzing device 3, and transmits the traffic information of the area including the travel position at the travel time (for example, the area within a predetermined distance from the travel position) to schedule/record analyzing device 3. External information acquiring unit 38 acquires the traffic information corresponding to the travel time and the travel position from external information providing device 6 via communication I/F unit 31.

The travel time information included in the request information for the traffic information includes the time of the travel period during which vehicle 4 travels on the road, and does not include the time of the stay period during which vehicle 4 stays at the destination. This is because, when vehicle 4 stays at the destination, the possibility that the traffic information affects the delivery record is low.

That is, external information acquiring unit 38 acquires the weather information and the traffic information during the travel period, and acquires the weather information during the stay period.

External information acquiring unit 38 identifies the travel period of vehicle 4 and the stay period at the destination of vehicle 4 based on the plan information and the record information. That is, external information acquiring unit 38 identifies the time from the arrival record time at the destination to the departure record time as the stay period. External information acquiring unit 38 identifies the time from the departure record time from the base or the destination to the arrival record time at the next destination or the base as the travel period.

FIG. 3 shows part of the weather information and the traffic information acquired by external information acquiring unit 38. For example, the weather information includes rainfall, and the rainfall is acquired at time intervals of 10 minutes after the departure record time from the base. The rainfall obtained between 8:00 and 8:50 is “0 mm”, the rainfall obtained at 9:00 is “2 mm”, the rainfall obtained at 9:10 is “10 mm”, and the rainfalls obtained at 9:20 and 9:30 are “20 mm”. These rainfalls are rainfalls in an area including the travel position of vehicle 4 at the relevant time. The weather information may further include information such as weather, a snowfall, a wind speed, a temperature, and a humidity.

The traffic information includes traffic congestion information, and the traffic information acquired at 8:00, 8:10, 8:40, and 9:30 indicates “no traffic congestion”, and the traffic information acquired at 8:20 and 8:30 indicates “traffic congestion”. The traffic information is not acquired during the stay period (from 8:50 to 9:25) of vehicle 4. The traffic information may further include traffic accident information, traffic regulation information, and the like.

### Storage Control Unit 39

Storage control unit 39 writes the external information (here, the weather information and the traffic information) acquired by external information acquiring unit 38 into memory 32.

### Difference Detecting Unit 40

Difference detecting unit 40 detects a temporal difference between the delivery plan and the delivery record based on the plan information and the record information stored in memory 32. That is, difference detecting unit 40 detects a difference between each scheduled time or each scheduled time period indicated in the plan information and each record time or each record time period indicated in the record information.

In the example of the plan information and the record information shown in FIG. 3, difference detecting unit 40 detects a difference of 10 minutes between the scheduled arrival time at the destination, 8:40, and the arrival record time at the destination, 8:50. Difference detecting unit 40 detects a difference of 5 minutes between the scheduled work time of 5 minutes and the work record time of 10 minutes for loading/unloading at the destination. Difference detecting unit 40 also detects a difference of 15 minutes between the scheduled departure time from the destination, 9:10, and the departure record time from the destination, 9:25.

### Factor Analyzing Unit 41

Factor analyzing unit 41 analyzes a factor causing the temporal difference between the delivery plan and the delivery record based on the detection result of difference detecting unit 40 and the external information stored in memory 32. That is, factor analyzing unit 41 refers to the external information up to the time at which the temporal difference occurs, and identifies a peculiar event as the factor causing the temporal difference.

In the example shown in FIG. 3, factor analyzing unit 41 refers to the weather information and the traffic information from 8:00 to 8:50 in order to analyze the factor causing the difference of 10 minutes between the scheduled arrival time at the destination, 8:40, and the arrival record time at the destination, 8:50. Factor analyzing unit 41 determines that the rainfall is not a factor causing the difference because the rainfall is “0 mm”. Furthermore, factor analyzing unit 41 identifies “traffic congestion” as the factor causing the difference in the arrival time because the traffic information at 8:20 and 8:30 indicates “traffic congestion”.

Difference detecting unit 40 refers to the weather information at the time when loading/unloading is performed in order to analyze the difference of 5 minutes between the scheduled work time of 5 minutes and the work record time of 10 minutes for the loading/unloading at the destination. The loading/unloading is performed from 8:55 to 9:05. Therefore, difference detecting unit 40 refers to the weather information at 8:50 and 9:00 as the weather information during this period. Factor analyzing unit 41 identifies that rainy weather is the factor causing the delay in the loading/unloading work because the rainfall at 9:00 is “2 mm”.

There is the difference of 15 minutes between the scheduled departure time from the destination, 9:10, and the departure record time from the destination, 9:25. This is due to a delay of 10 minutes in the arrival time and a delay of 5 minutes in the loading/unloading. Therefore, difference detecting unit 40 does not detect a factor causing the difference in the departure time.

### Display Control Unit 42

Display control unit 42 outputs information indicating the analysis result of the factor causing the temporal difference by factor analyzing unit 41 to the display device via input/output I/F unit 33, thereby performing control to display the analysis result on the display device. For example, the result of the factor analysis shown in FIG. 3 is displayed on the display device.

### Processing Steps of Schedule/Record Analyzing Device 3

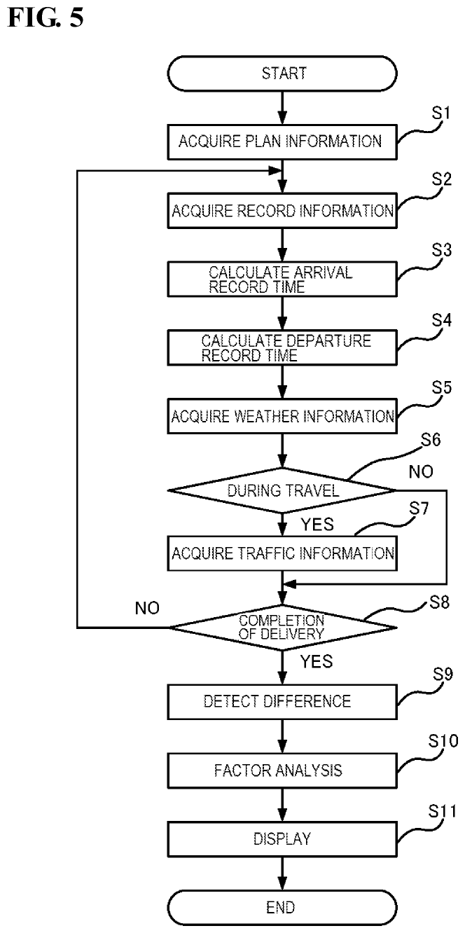

FIG. 5 is a flowchart showing an example of processing steps of schedule/record analyzing device 3. Referring to FIG. 5, plan information acquiring unit 36 acquires the plan information from delivery plan creating device 2 via communication I/F unit 31, and stores the acquired plan information in memory 32 (step S1).

Record information acquiring unit 37 acquires the record information from vehicle 4 via communication I/F unit 31, and stores the acquired record information in memory 32 (step S2). The record information is acquired in real time.

Record information acquiring unit 37 calculates the arrival record time at the destination or the base by collating the information of the travel position and the travel time of vehicle 4 included in the record information with the position information of the base and the destination indicated in the plan information (step S3).

Record information acquiring unit 37 calculates the departure record time from the destination or the base by collating the information of the travel position and the travel time of vehicle 4 included in the record information with the position information of the base and the destination indicated in the plan information (step S4).

External information acquiring unit 38 transmits request information for weather information to external information providing device 6 and receives the weather information from external information providing device 6 every time the travel time of vehicle 4 elapses 10 minutes. Storage control unit 39 stores the weather information received by external information acquiring unit 38 in memory 32 (step S5).

In a case where the travel time of vehicle 4 is included in the travel period of vehicle 4 (YES in step S6), external information acquiring unit 38 transmits request information for traffic information to external information providing device 6 and receives the traffic information from external information providing device 6 every time the travel time elapses 10 minutes. Storage control unit 39 stores the traffic information received by external information acquiring unit 38 in memory 32 (step S7).

In a case where the travel time of vehicle 4 is not included in the travel period of vehicle 4 (NO in step S6), external information acquiring unit 38 does not transmit request information of traffic information.

The processing from step S2 to S7 is repeatedly executed until vehicle 4 returns to the base after the delivery by vehicle 4 is completed (step S8).

Difference detecting unit 40 detects a temporal difference between the delivery plan and the delivery record based on the plan information and the record information stored in memory 32 (step S9).

Factor analyzing unit 41 analyzes a factor causing the temporal difference between the delivery plan and the delivery record based on the detection result of difference detecting unit 40 and the weather information and the traffic information stored in memory 32 (step S10).

Display control unit 42 displays the analysis result of the factor causing the temporal difference by factor analyzing unit 41 on the display device (step S11).

### Effects and the Like of Embodiment 1

As described above, according to Embodiment 1 of the present disclosure, schedule/record analyzing device 3 can acquire external information by narrowing down the area and the time based on the record information, and store the external information in memory 32. This makes it possible to acquire the external information at low cost.

For example, external information around the travel position of vehicle 4 is acquired, while external information in other positional range is not acquired, so that the area for acquiring external information can be narrowed down.

The external information includes at least one of weather information, traffic information, state information of an inside of a trunk of vehicle 4, state information of vehicle 4, state information of a worker, traffic signal information, or fee information of a toll road. Thus, schedule/record analyzing device 3 can acquire various kinds of external information on an event based on which there is a possibility of affecting the delivery record for the delivery plan at low cost.

Schedule/record analyzing device 3 identifies the travel period of vehicle 4 and the stay period at the destination of vehicle 4 based on the plan information and the record information, and changes the combination of the external information to be acquired during the travel period and the stay period. That is, schedule/record analyzing device 3 acquires weather information and traffic information during the travel period, and acquires weather information during the stay period. In a period during which vehicle 4 travels, it is highly necessary to acquire the traffic information. On the other hand, the necessity of acquiring the traffic information is low in a period during which vehicle 4 stays at the destination. Therefore, this configuration allows the acquisition of external information necessary for factor analysis of the difference between the plan and the record, and avoids the acquisition of external information unnecessary for factor analysis. Thus, appropriate external information can be acquired in accordance with the state of vehicle 4.

### EMBODIMENT 2

In Embodiment 1, external information is acquired at fixed time intervals (for example, 10-minute intervals). In an Embodiment 2, an example in which the time interval for acquiring the external information is variable will be described. The configuration of schedule/record management system 1 is the same as that of Embodiment 1. Therefore, the detailed description thereof will not be repeated here. Referring to FIG. 2, external information acquiring unit 38 basically acquires external information at predetermined time intervals (for example, 10-minute intervals) as in Embodiment 1. External information acquiring unit 38 determines a frequency for acquiring the external information in accordance with the content of the acquired external information.

For example, in a case where the acquired weather information indicates a rainfall of 5 mm or more, external information acquiring unit 38 may change the time interval for acquiring the weather information to a frequency (for example, at 2-minute intervals) higher than usual. Furthermore, in a case where the acquired weather information indicates a rainfall of less than 5 mm, external information acquiring unit 38 may reset the time interval for acquiring the weather information to the original 10-minute interval.

Furthermore, external information acquiring unit 38 may change the time interval for acquiring the weather information to a frequency higher than usual (for example, at 2-minute intervals) in the same manner also in a case where the weather information includes supplementary information indicating abnormal weather (for example, weather warning information). Furthermore, in a case where the acquired weather information no longer includes the supplementary information indicating abnormal weather, external information acquiring unit 38 may reset the time interval for acquiring the weather information to the original 10-minute interval.

External information acquiring unit 38 may change the time interval for acquiring external information other than the weather information in accordance with the content of the external information.

According to Embodiment 2 of the present disclosure, in a case where it can be determined that an unusual event has occurred based on the external information, it is possible to take measures such as acquiring the external information at a higher frequency than usual.

In particular, weather information indicating abnormal weather can be acquired at a higher frequency than usual, and thus weather information based on which there is a higher possibility of affecting the delivery record can be acquired at a higher frequency, thereby contributing to accurate factor analysis.

### Modification of Embodiment 2

In Embodiment 2, the time interval for acquiring weather information is changed in accordance with the content of the weather information. In contrast, the time interval for acquiring weather information may be changed in accordance with the content of weather forecast information.

External information acquiring unit 38 transmits the position information of vehicle 4 to a server that provides weather forecast via communication I/F unit 31, and receives the weather forecast information from the server.

External information acquiring unit 38 may change the time interval for acquiring weather information from the normal 10-minute interval to a higher frequency 2-minute interval based on the received weather forecast information, for example, in a case where a rainfall of 5 mm or more is expected within 30 minutes.

According to the present modification, for example, in a case where a possibility that the rainfall will increase is detected based on the weather forecast information, it is possible to take measures such as acquiring the weather information at a higher frequency than usual. This can contribute to accurate factor analysis.

### EMBODIMENT 3

In Embodiment 1 and Embodiment 2, storage control unit 39 stores all the external information acquired by external information acquiring unit 38 in memory 32. In contrast, in an Embodiment 3, a method for reducing external information stored in memory 32 compared to Embodiment 1 and Embodiment 2 will be described.

That is, storage control unit 39 may write changed external information in memory 32, among pieces of the external information acquired by external information acquiring unit 38, and may not write unchanged external information in memory 32.

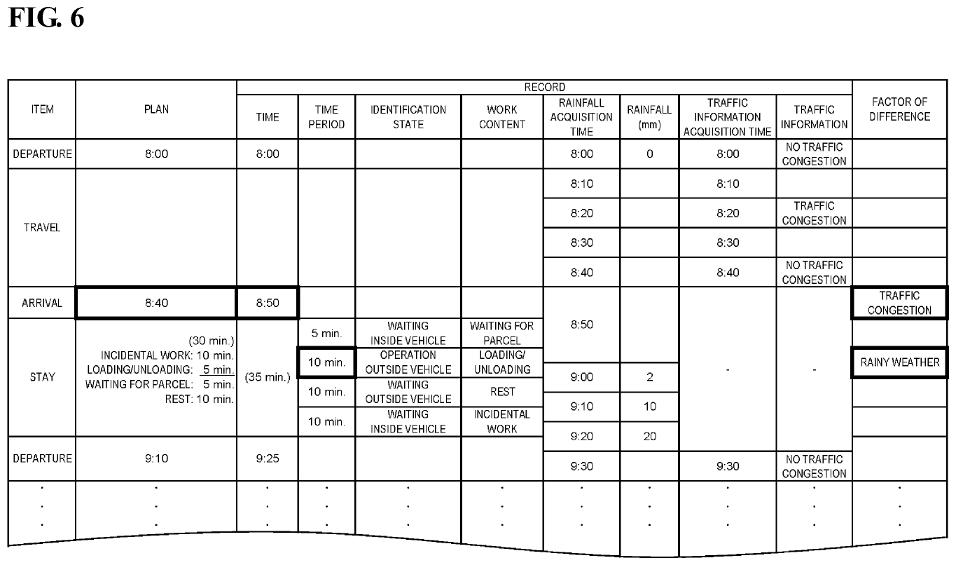

FIG. 6 is a diagram showing an example of a result of a factor analysis displayed on the display device by factor analyzing unit 41. FIG. 6 shows part of the external information stored in memory 32 by storage control unit 39. Here, the external information acquired by external information acquiring unit 38 is the same as that in Embodiment 1.

As shown in FIG. 3, the rainfall indicated by the weather information from 8:00 to 8:50 is “0 mm”. Therefore, as shown in FIG. 6, storage control unit 39 stores only the rainfall of “0 mm” at 8:00, which changed from the previous time, in memory 32, and does not store the rainfall from 8:10 to 8:50 in memory 32. In the same manner, as shown in FIG. 3, the rainfalls indicated by the weather information at 9:20 and 9:30 are “20 mm”. Therefore, as shown in FIG. 6, storage control unit 39 stores only the rainfall of “20 mm” at 9:20, which changed from the previous time, in memory 32, and does not store the rainfall at 9:30.

As shown in FIG. 3, the traffic information at 8:00 and 8:10 indicates “no traffic congestion”. Therefore, as shown in FIG. 6, storage control unit 39 stores only the traffic information of “no traffic congestion” at 8:00, which changed from the previous time, in memory 32, and does not store the traffic information of “no traffic congestion” at 8:10 in memory 32. In the same manner, as shown in FIG. 3, the traffic information at 8:20 and 8:30 indicates “traffic congestion”. Therefore, as shown in FIG. 6, storage control unit 39 stores only the traffic information of “traffic congestion” at 8:20, which changed from the previous time, in memory 32, and does not store the traffic information of “traffic congestion” at 8:30 in memory 32.

Factor analyzing unit 41 performs factor analysis by regarding the rainfall at 8:10 to 8:50, which is not stored in memory 32, as the same as the rainfall of “0 mm” at 8:00, which is the latest rainfall in the past stored in memory 32. Factor analyzing unit 41 performs factor analysis by regarding the rainfall at 9:30, which is not stored in memory 32, as the same as the rainfall of “20 mm” at 9:20, which is the latest rainfall in the past stored in memory 32.

Factor analyzing unit 41 performs factor analysis by regarding the traffic information at 8:10, which is not stored in memory 32, as the same as the traffic information of “no traffic congestion” at 8:00, which is the latest traffic information in the past stored in memory 32. Factor analyzing unit 41 performs factor analysis by regarding the traffic information at 8:30, which is not stored in memory 32, as the same as the traffic information of “traffic congestion” at 8:20, which is the latest traffic information in the past stored in memory 32.

According to Embodiment 3 of the present disclosure, in a case where there is a change in the external information, the external information can be stored in memory 32, and in a case where there is no change in the external information, the external information is not stored in memory 32. This can reduce the capacity of the external information stored in memory 32, thereby reducing the maintenance cost of the external information.

### Supplementary Note

Some or all of the components included in schedule/record analyzing device 3 may be formed of one or more semiconductor devices such as system LSIs.

The computer program may be recorded in a computer-readable non-transitory recording medium, for example, an HDD, a CD-ROM, a semiconductor memory, or the like, and distributed. The computer program may be distributed by being transmitted via an electric communication line, a wireless or wired communication line, a network represented by the Internet, data broadcasting, or the like. Schedule/record analyzing device 3 may be implemented by a plurality of computers or a plurality of processors.

Some or all of the functions of schedule/record analyzing device 3 may be provided by cloud computing. Furthermore, at least some of the embodiments and modifications may be combined as desired.

It should be understood that the embodiments disclosed herein are illustrative and non-restrictive in every respect. The scope of the present disclosure is defined by the claims, not in the sense described above, and is intended to include all modifications within the scope and meaning equivalent to the claims.

### REFERENCE SIGNS LIST

1 schedule/record management system, 2 delivery plan creating device (external information acquiring device), 3 schedule/record analyzing device, 4 vehicle, 5 network, 6 external information providing device, 31 communication I/F unit, 32 memory, 33 input/output I/F unit, 34 processor, 35 bus, 36 plan information acquiring unit, 37 record information acquiring unit, 38 external information acquiring unit, 39 storage control unit, 40 difference detecting unit, 41 factor analyzing unit, 42 display control unit, 60 map, 61 geofence, 62 geofence, 71 first point

1. An external information acquiring device comprising:
a record information acquiring circuit configured to acquire record information indicating a delivery record of a parcel by a vehicle;
an external information acquiring circuit configured to acquire, based on the acquired record information, external information on an event based on which there is a possibility of occurrence of a temporal difference between the delivery record and a delivery plan of the parcel by the vehicle; and
a storage control circuit configured to write the acquired external information in a storage device.

2. The external information acquiring device according to claim 1, wherein
the record information includes travel position information of the vehicle, and
the external information acquiring circuit is configured to acquire the external information, based on the travel position information.

3. The external information acquiring device according to claim 1, wherein the external information includes at least one of weather information, traffic information, state information of an inside of a trunk of the vehicle, state information of the vehicle, state information of a worker who performs delivery work of the parcel by the vehicle, traffic signal information, or fee information of a toll road.

4. The external information acquiring device according to claim 3, further comprising:
a plan information acquiring circuit configured to acquire plan information indicating the delivery plan, wherein
the external information acquiring unit is configured to identify, based on the plan information and the record information, a travel period of the vehicle and a stay period during which the vehicle stays at a destination of the parcel, and to change a combination of pieces of the external information to be acquired during the travel period and the stay period.

5. The external information acquiring device according to claim 4, wherein the external information acquiring unit is configured to acquire the weather information and the traffic information during the travel period and to acquire the weather information during the stay period.

6. The external information acquiring device according to claim 1, wherein the external information acquiring unit is configured to determine, based on the acquired external information, a frequency for acquiring the external information.

7. The external information acquiring device according to claim 6, wherein the external information acquiring unit is configured to increase a frequency for acquiring weather information in a case where the weather information acquired as the external information indicates an abnormal weather, compared with a case where the weather information indicates a normal weather.

8. The external information acquiring device according to claim 6, wherein the external information acquiring unit is configured to further acquire weather forecast information and to determine, based on the weather forecast information, a frequency for acquiring weather information as the external information.

9. The external information acquiring device according to claim 1, wherein the storage control unit is configured to write changed external information in the storage device, among pieces of the acquired external information.

10. A method for acquiring external information, the method comprising:
acquiring, by an external information acquiring device, record information indicating a delivery record of a parcel by a vehicle;
acquiring, by the external information acquiring device, based on the acquired record information, external information on an event based on which there is a possibility of occurrence of a temporal difference between the delivery record and a delivery plan of the parcel by the vehicle; and
writing, by the external information acquiring device, the acquired external information in a storage device.

11. A non-transitory computer-readable storage medium storing a computer program for causing a computer to function as:
a record information acquiring unit configured to acquire record information indicating a delivery record of a parcel by a vehicle;
an external information acquiring unit configured to acquire, based on the acquired record information, external information on an event based on which there is a possibility of occurrence of a temporal difference between the delivery record and a delivery plan of the parcel by the vehicle; and
a storage control unit configured to write the acquired external information in a storage device.

12. The external information acquiring device according to claim 2, wherein the external information includes at least one of weather information, traffic information, state information of an inside of a trunk of the vehicle, state information of the vehicle, state information of a worker who performs delivery work of the parcel by the vehicle, traffic signal information, or fee information of a toll road.

13. The external information acquiring device according to claim 12, further comprising:
a plan information acquiring circuit configured to acquire plan information indicating the delivery plan, wherein
the external information acquiring unit is configured to identify, based on the plan information and the record information, a travel period of the vehicle and a stay period during which the vehicle stays at a destination of the parcel, and to change a combination of pieces of the external information to be acquired during the travel period and the stay period.

14. The external information acquiring device according to claim 13, wherein the external information acquiring unit is configured to acquire the weather information and the traffic information during the travel period and to acquire the weather information during the stay period.

15. The external information acquiring device according to claim 2, wherein the external information acquiring unit is configured to determine, based on the acquired external information, a frequency for acquiring the external information.

16. The external information acquiring device according to claim 15, wherein the external information acquiring unit is configured to increase a frequency for acquiring weather information in a case where the weather information acquired as the external information indicates an abnormal weather, compared with a case where the weather information indicates a normal weather.

17. The external information acquiring device according to claim 15, wherein the external information acquiring unit is configured to further acquire weather forecast information and to determine, based on the weather forecast information, a frequency for acquiring weather information as the external information.

18. The external information acquiring device according to claim 2, wherein the storage control unit is configured to write changed external information in the storage device, among pieces of the acquired external information.

19. The external information acquiring device according to claim 3, wherein the storage control unit is configured to write changed external information in the storage device, among pieces of the acquired external information.

20. The external information acquiring device according to claim 4, wherein the storage control unit is configured to write changed external information in the storage device, among pieces of the acquired external information.
